(19) United States
(12) Patent Application Publication
(10) Pub. No.: US 2005/0008798 A1
(43) Pub. Date: Jan. 13, 2005

(54) Reams of wrapped paper accompanied by one or more printed manufacturer or retailer coupons or coupon booklets

(76) Inventor: Michael R. Nowak, Hilbert, WI (US)

Correspondence Address: Philip M. Weiss;Weiss & Weiss, 310 Old Country Road, Garden City, NY, 11530, US

(21) Appl. No.: 10/616,590

(22) Filed: Jul. 10, 2003

(51) Int. Cl. F16L 1/00

(52) U.S. Cl. 428/34.1; 428/131

(57) ABSTRACT

Wrapped reams of copier and printer paper comprising one or more manufacturer or retailer coupons or coupon booklets.

### FIELD OF THE INVENTION

The present invention relates to wrapped reams of copier or printer paper with printed manufacturer or retailer coupons or coupon booklets inserted inside the packaged ream, printed on either the outside or inside of the ream wrap itself, or attached to either the inside or outside of the wrapped product.

### BACKGROUND OF THE INVENTION

Reams (i.e., 500 sheets) of cut paper (8^{1/2}×11, etc.) for copy machines, computers, printers, and other home and office applications are most commonly packaged for shipping, storage, and retail sale in ream wrap made of various wrap materials, including coated papers and solid plastic films. As more people have acquired home computers and printers, the use of copier and printer paper by individual consumers has increased. Individual consumers typically purchase wrapped reams of paper at an office supply store, retail store, or through an office supply catalog. Reams of copier and printer paper traditionally are purchased by offices, businesses, public institutions, and other entities in larger boxed quantities. The ream wrapper itself is sold to paper mills, which make the copier or printer paper and package the reams on packaging lines. The ream wrap is often printed with the name of the paper mill or some other corporate logo or marking denoting the name of the paper manufacturer. Ream wrap also is sold under the names of equipment makers (i.e., Hewlett Packard, Xerox, etc.) or other private label resellers of reamed paper (i.e., Office Depot, Viking, Corporate Express, etc.). Such reams are wrapped in ream wrap printed with the name or corporate logo of the private label seller or equipment manufacturer.

### SUMMARY OF THE INVENTION

The present invention relates to a ream wrapper comprising one or more printed manufacturer or retailer coupon or coupon booklets which are included inside the wrapped ream of paper. It is an object of the invention for a printed advertisement to be placed on the ream wrapper notifying one of inclusion of coupons inside the ream wrapper.

The present invention relates to a ream wrapper comprising one or more printed manufacturer or retailer coupons which are printed on either the inside or outside of the wrapper. It is an object of the invention for the ream wrapper to further comprising solid or dotted lines for a user to cut out the coupons. It is an object of the present invention for the ream wrapper to further comprise perforations precut or pressed into the wrapper.

The present invention relates to a ream wrapper comprising one or more printed coupons which are attached to an inside surface or outside surface of the ream wrap. It is an object of the invention for the coupons to be attached using adhesive backing. It is an object of the invention for the ream wrap to be clear. It is an object of the present invention for the ream wrap to comprise a clear window.

The present invention relates to wrapped reams of paper with printed retailer or manufacturer coupons or coupon booklets inserted inside the ream, printed on the outside or inside of the ream wrap, or otherwise attached to the inside or outside of the wrapped ream. This method of selling is particularly designed to capture the attention of the individual consumer of reamed papers—a marketplace that is particularly competitive with the proliferation of home office and personal computers and printers.

The present invention relates to wrapped reams of copier and printer paper which include one or more promotional coupons or coupon booklets for a manufacturer or retailer of some other product. It is an object of the present invention to attract the particular attention of the consumer purchasing individually wrapped reams of paper for home office or personal use. It is also an object of the invention to include coupons in or on wrapped reams sold to businesses, offices, public institutions, and other entities.

It is an object of the present invention to include one or more printed manufacturer or retailer coupons or coupon booklets inside the wrapped ream of paper. It also is an object of the invention to print one or more promotional coupons on either the inside or outside of the ream wrap itself so that the individual coupon are detachable by cutting with a scissor, or tearing along perforated lines, once the wrapped package is opened. It is a further object of the present invention to attach one or more printed manufacturer or retailer coupons to either the inside or outside of the wrapped reams by any means that makes the coupons easily detachable by the consumer or user of the paper (e.g., one embodiment may be a peel-away adhesive-backed coupon attached to either the inside or outside of the ream).

### BRIEF DESCRIPTION OF THE DRAWINGS

FIG. 1 is a top view of an embodiment of the present invention;

FIG. 1a is a sectional view of FIG. 1;

FIG. 2 is a top view of an embodiment of the present invention;

FIG. 3 is a is a top view of an embodiment of the present invention;

FIG. 4 is an internal view of an embodiment of the present invention;

FIG. 5 is a is a top view of an embodiment of the present invention;

FIG. 6 is a is a top view of an embodiment of the present invention; and

FIG. 6a is a section view of FIG. 6.

### DETAILED DESCRIPTION OF THE INVENTION

In one embodiment of the present invention, one or more printed manufacturer or retailer coupons or coupon booklets (e.g., promoting the sale of an office product, or other retail or manufactured product—i.e., a fast food or nonfood consumer product) are included inside the wrapped ream of paper. Thus the coupons or coupon booklets are found inside with the cut paper when the consumer or user opens the ream. The printed ream wrapper may or may not include a printed advertisement for, or notification of, the inclusion of the coupons or coupon booklets on the outside of the wrapper itself in addition to other logos or corporate names or markings associated with the wrapped paper.

In another embodiment, the ream wrap is printed with one or more manufacturer or retailer coupons on either the inside or outside of the wrapper. Once the ream of paper is opened and prior to discarding the ream wrap, the consumer may cut out the coupons with a scissor or other means along solid or dotted lines. The coupon or coupons printed on the inside or outside of the label also may be enclosed within perforations pre-cut or pressed into the ream wrapper. The coupons are detachable by the consumer by tearing along the perforated lines. The ream wrap itself may be printed with an advertisement for the coupon or coupons on the outside of the wrapper.

In another embodiment, one or more detachable manufacturer or retailer coupons are mounted on either the inside or outside of the ream wrap by any well-known means. For instance, one or more printed coupons may be attached using an adhesive backing that allows the consumer to easily peel off the coupon or otherwise remove it from the ream wrap. Coupons are attached in this manner to other packaged goods, such as packaged food or nonfood products like diapers or batteries.

In another embodiment of the present invention, the inside of the ream wrapper is printed with a series of advertisements and/or coupons for a number of various retailers and manufacturers, in a manner similar to the coupons printed continuously across the back of grocery store and other retail cash register receipts or similar to advertisements printed in the church bulletin. Individual coupons are separated by printed solid or dotted lines along which the user or consumer can cut with a scissor or other means to detach the coupons.

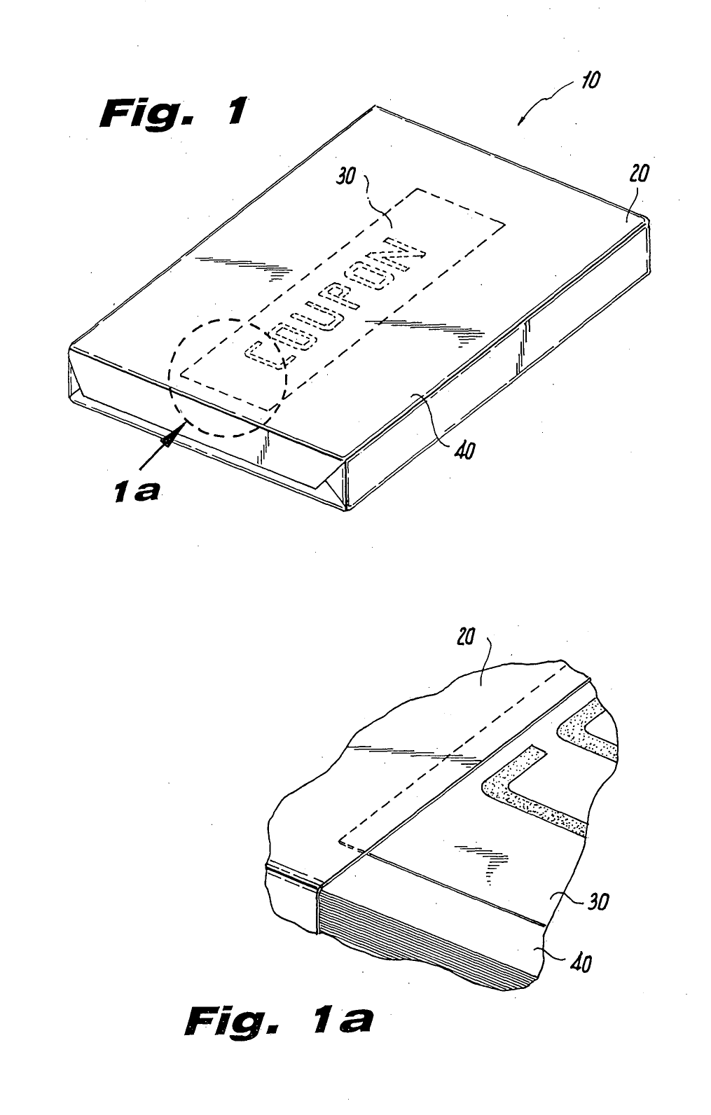

FIG. 1 illustrates a ream 10 comprising a clear ream wrapper 20 having coupons 30 placed on top of the paper 40. In this embodiment, a user can view both the paper 40 and the coupons 30. The coupons 30 can be removed from the ream wrapper 20 once the ream wrapper is opened.

FIG. 1a illustrates the clear ream wrap 20 having the coupon 30 underneath the ream wrap 20 and on top of the paper 40.

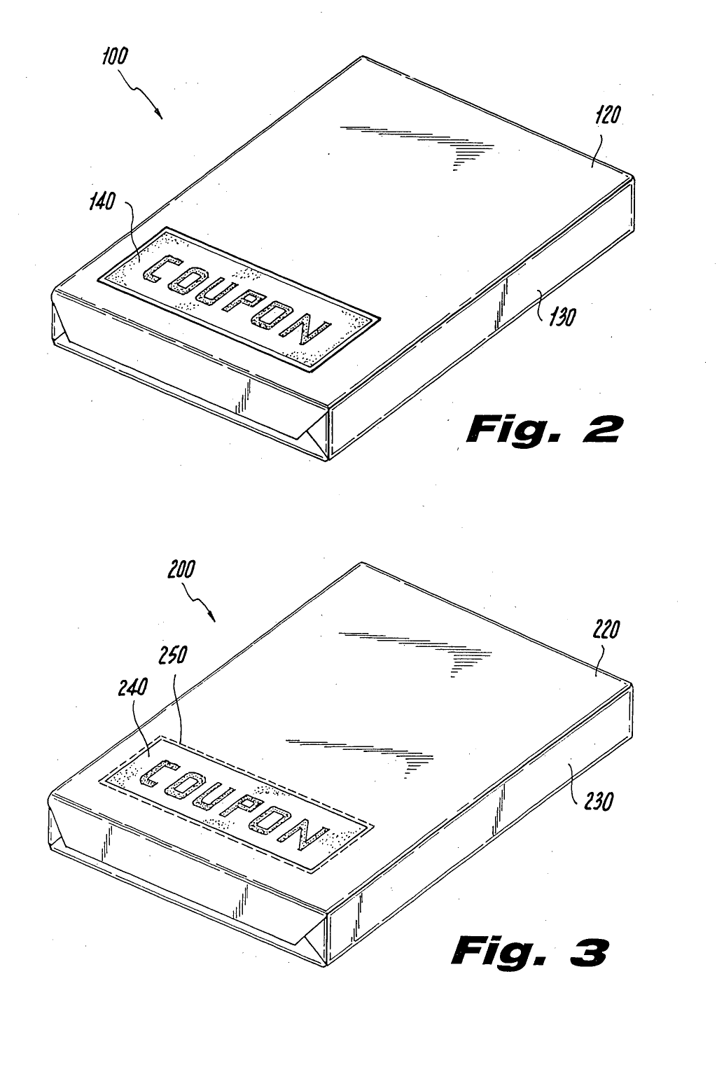

FIG. 2 illustrates a ream 100 comprising a ream wrapper 120 having a ream of paper 130 placed inside the ream wrapper. The ream wrapper 120 itself have coupons 140 printed directly on the wrapper.

FIG. 3 illustrates a ream 200 comprising a ream wrapper 220 having a ream of paper 230 placed inside the ream wrapper. The ream wrapper 220 has a 240 coupon attached to the wrapper by perforations 250.

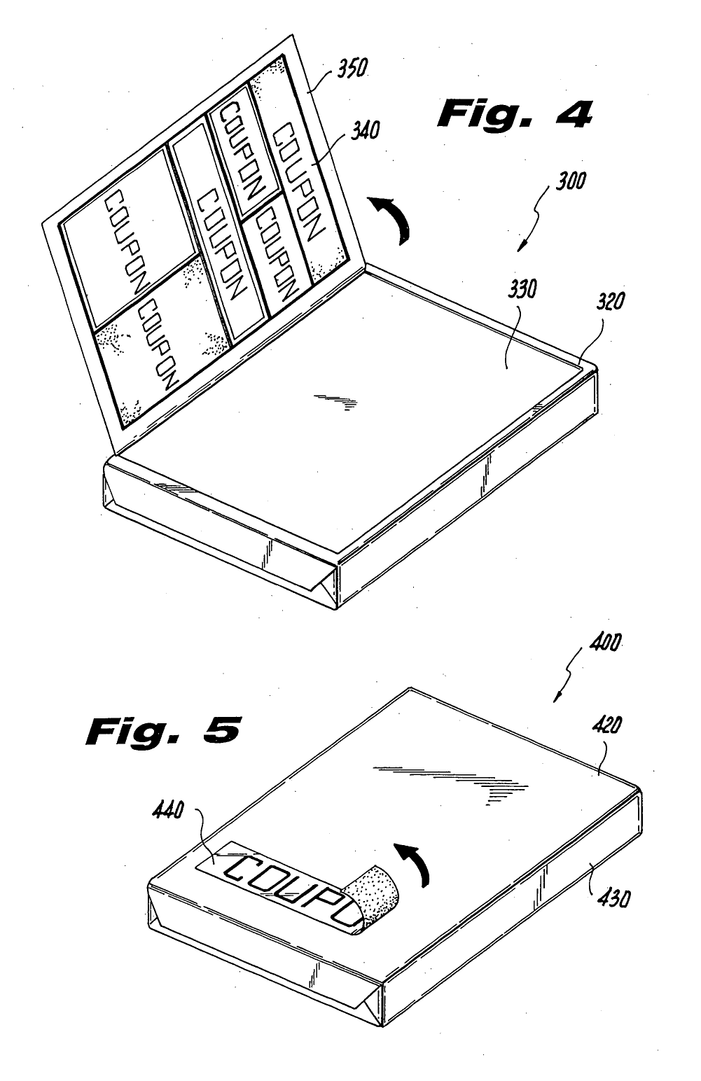

FIG. 4 illustrates a ream 300 comprising a ream wrapper 320 having a ream of paper 330 placed inside the ream wrapper. Coupons 340 are attached to the inside sheet 350 of the ream wrapper 320. An example of such attachment can be adhesive or tape.

FIG. 5 illustrates a ream 400 comprising a ream wrapper 420 having a ream of paper 430 placed inside the ream wrapper. Coupon 440 is attached by an adhesive to the ream wrap 420 so that the coupon can be peeled off the ream wrap.

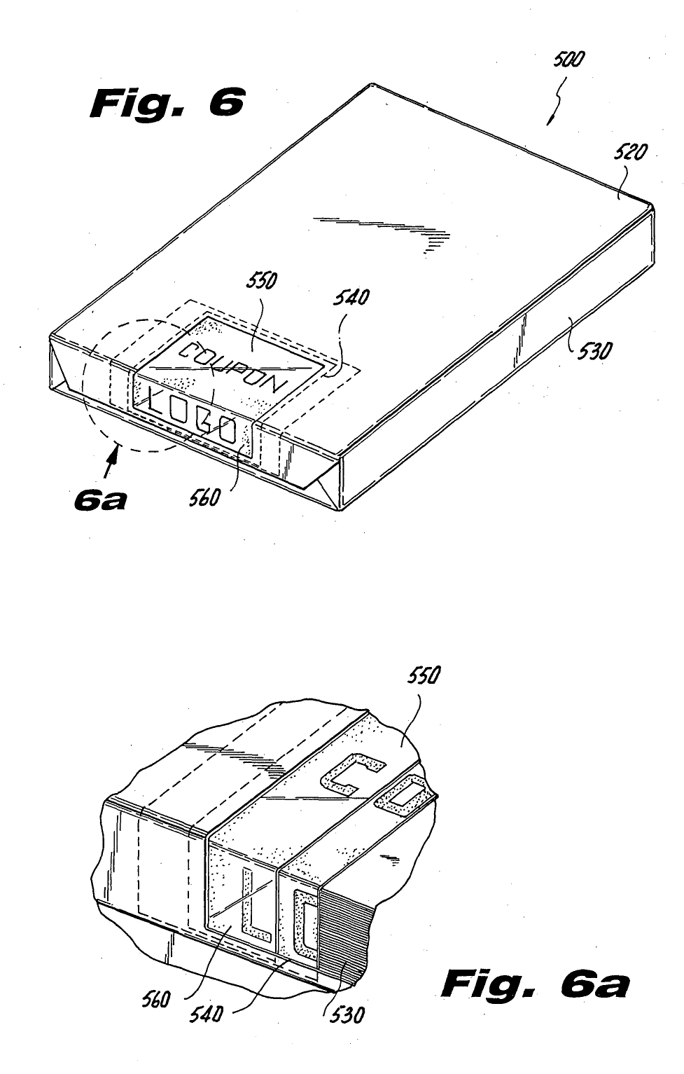

FIG. 6 illustrates a ream 500 comprising a ream wrapper 520 having a ream of paper 530 placed inside the ream wrapper. A clear window 540 is part of the ream wrapper 520 which allows coupon 550 and logo 560 to be shown to a customer. Further, the paper 530 can also be seen through window 540. In this embodiment, a user can see the coupon or logo by viewing the side of the ream wrap which usually faces the customer.

FIG. 6a illustrates the paper 530 and the window 540 which allows a user to see the coupon 550 and logo 560.

1. A ream wrapper comprising one or more printed manufacturer or retailer coupon or coupon booklets which are included inside the wrapped ream of paper.

2. The ream wrapper of claim 1 wherein a printed advertisement is placed on the ream wrapper notifying one of inclusion of said coupons inside said ream wrapper.

3. A ream wrapper comprising one or more printed manufacturer or retailer coupons which are printed on either the inside or outside of said wrapper.

4. The ream wrapper of claim 3 further comprising solid or dotted lines for a user to cut out said coupons.

5. The ream wrapper of claim 3 further comprising perforations precut or pressed into said wrapper.

6. A ream wrapper comprising one or more printed coupons which are attached to an inside surface or outside surface of said ream wrap.

7. The ream wrapper of claim 6 wherein said coupons are attached using adhesive backing.

8. The ream wrapper of claim 1 wherein said ream wrap is clear.

9. The ream wrapper of claim 1 wherein said ream wrap comprises a clear window.
